(19) United States
(12) Patent Application Publication
(10) Pub. No.: US 2013/0036653 A1
(43) Pub. Date: Feb. 14, 2013

(54) Systems and Methods for the Handling for Aquatic Species

(71) Applicant: Michael Holliman, Manteca, CA (US)

(72) Inventor: Michael Holliman, Manteca, CA (US)

(21) Appl. No.: 13/164,756

(22) Filed: Jun. 20, 2011

Related U.S. Application Data
(60) Provisional application No. 61/356,375, filed on Jun. 18, 2010.

(51) Int. Cl. A01K 79/02

(52) U.S. Cl. 43/17.1

(57) ABSTRACT

An inventive device for the handling and affecting the physiological state of an aquatic species with a pair of gloves, a multiplicity of electrodes, and a pulsator attached to the electrodes, so that when the pulsator is activated the current, alters the physiological state of the aquatic species.

### RELATED APPLICATIONS

This application claims the benefit of U.S. Provisional Application No. 61/356,375, filed Jun. 18, 2010, the contents herein incorporated into this application by reference.

### BACKGROUND

The present inventive subject matter relates to the systems and methods for the handling of aquatic species using electric fields and gloves.

The maximum transfer of energy from water to a fish occurs when the fish's electrical conductivity matches the electrical conductivity of the surrounding water. In most circumstances, a fish's body is normally more conductive than fresh water. As a result, the fish's body acts as a “voltage divider” when swimming through fresh water, and the gradient of an electrical field in the body of a fish will typically be less than the voltage gradient in the same space filled by fresh water. That is, the voltage gradient is altered in a region proximate a fish in the zone of an electric fish barrier. Nevertheless, all other factors remaining equal, the voltage gradient in the body of a fish will be roughly proportional to the voltage gradient in the same region of fresh water when no fish are present. Accordingly, if the voltage gradient in a region of water is doubled, the voltage gradient across the fish (and the electrical current through the fish) will also double. The effectiveness of an electric fish barrier on a particular fish, therefore, depends on the voltage field gradient produced by the electric fish barrier.

The voltage gradients in the region of water may be adjusted to cause a physiological reaction in the fish. If a voltage gradient in a region of water is too weak, the fish will not feel appreciable discomfort, and will travel undaunted by the electric fish barrier. An “annoying region” will cause a fish to turn around and travel the preferred route. Conversely, early experiments have demonstrated that if a moderately annoying region of the electric barrier is too narrow to allow a fish to turn around, then the rapidly swimming fish passes quickly through the “annoying” region and then into the “painful region”. The rapid transition from the annoying to the painful may induce large fish to react so violently in their attempt to change direction that they have actually snapped their own spine. As a result of these observations, an ideal fish barrier will normally have a wide region with a moderately annoying voltage gradient, increasing at a rate that causes increasing discomfort to fish of various sizes and species, but allowing ample room for a fish experiencing discomfort to turn around before passing completely through the annoying region and into a painful or lethal region. The awareness of the field gradient should, therefore, not be a sudden discovery, but a gradually growing annoyance. Whether a fish barrier is effective, ineffective or harmful is thus a function of the shape of the boundary, the thickness and the intensity of a voltage gradient produced by an electric fish barrier.

The current passing through a fish depends on a variety of factors such as the conductivity of the water at both ends of the fish, the total resistance in a conductive path of water, and the size and species of a fish being repelled, etc. Typically, higher gradients are necessary to control the travel and migration of smaller fish, and lower gradients are effective for larger fish. The effectiveness of a particular strength gradient also depends on the species of fish, and whether the motion of the water reliably flows in a direction to orient the fish along the axis of the strongest gradient, which is perpendicular to the equipotential voltage plane. However, a voltage gradient of one hundred volts per meter has been observed to establish a good base-line voltage gradient for effectively and yet safely deterring average size fish from entering a prohibited area. It is understood that higher and lower voltage gradients may be appropriate according to a variety of factors.

### SUMMARY

The present inventive subject matter overcomes problems in the prior art by providing for systems and methods for an apparatus to handling and affect the physiological state of an aquatic species, said apparatus having a pair of gloves, a multiplicity of electrodes, said electrodes attached to each glove; a pulsator, said pulsator attached to the electrodes; such that when the pulsator is activated, and the aquatic species is handled by the gloves, the current passing from one electrode to another, alters the physiological state of the aquatic species.

Another example of the inventive subject matter is a method for the handling and affecting the physiological state of an aquatic species, said method comprising the steps of handling the aquatic species with a pair of gloves, wherein said gloves further comprise a multiplicity of electrodes, wherein said electrodes are attached to each glove, and a pulsator, said pulsator attached to the electrodes; connecting the gloves to a pulsator, activating the pulsator, such that when the pulsator is activated, the physiological state of the aquatic species is affected.

An apparatus for the handling and affecting the physiological state of an aquatic species, said apparatus having a pair of gloves, a multiplicity of electrodes, with the electrodes attached to each glove; a pulsator, the pulsator attached to the electrodes; so \ that when the pulsator is activated, and the aquatic species is handled by the gloves, the current passing from one electrode to another, alters the physiological state of the aquatic species.

A method for the handling and affecting the physiological state of an aquatic species, the method with the steps of handling the aquatic species with a pair of gloves, the gloves further having a multiplicity of electrodes, where the electrodes are attached to each glove, and a pulsator, said pulsator attached to the electrodes; then connecting the gloves to a pulsator, then activating the pulsator, so that when the pulsator is activated, the physiological state of the aquatic species is affected.

The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

FIG. 1 is a front view of the pair of gloves with the embodiment of the inventive subject matter.

FIG. 2 is a view of the gloves with the inventive subject matter connected to a pulsator.

FIG. 3 is system diagram of the inventive subject matter.

FIG. 4 is close in view of a glove with an electrode and a switch mounted to the glove.

FIG. 5 is a diagram of the glove being used in connection with fish processing.

FIG. 6 is a diagram of the glove being used on an electrofishing boat.

FIGS. 7A-7D is an alternate embodiment of the gloves with electrodes being placed on various places on the gloves.

FIG. 8 is a view of the inventive subject matter used proximate to a holding tank.

### DETAILED DESCRIPTION

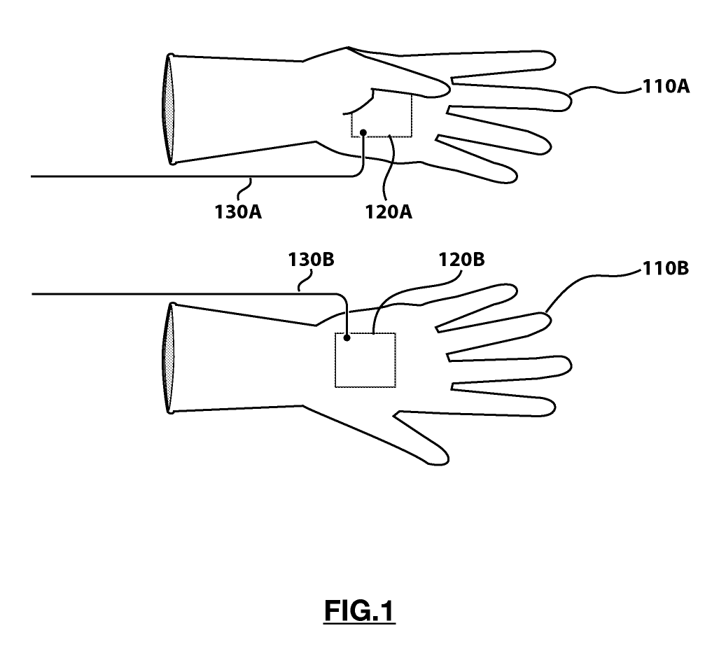

Representative embodiments according to the inventive subject matter are shown in FIGS. 1-8 wherein similar features share common reference numerals.

Now referring to FIG. 1 which depicts the inventive subject matter of the gloves 110A, 110B, attached to the gloves are electrodes 120A,120B, which are attached by wires 130A, 130B to an electric power source (not shown). The gloves 110A, 110B would typically be impermeable, non-conducting, water resistant gloves that are well known in the arts. Such gloves may be made from plant materials, such as rubber gloves; the gloves may also be made from animal products, such as deer and/or cow, and sealed to prevent permeation of water; or the gloves may also be made from a synthetic material, such as, synthetic rubber, and/or propoethylene. The gloves should be thick enough to prevent any chance of conductivity. The electrodes attached to the glove can be made from any number of conductive materials, such as, aliminum, copper, silver, gold, or alloys of other metals with the aforementioned conductive materials. The conductive materials can be infused into a top layer of the glove or the conductive material may be attached separated in the form of a strap or tape. The important aspect of the conductive material is that it will move in concert with the palm and/or fingers of the glove so that when an object is gripped the conductive material will come into contact with the gripped object.

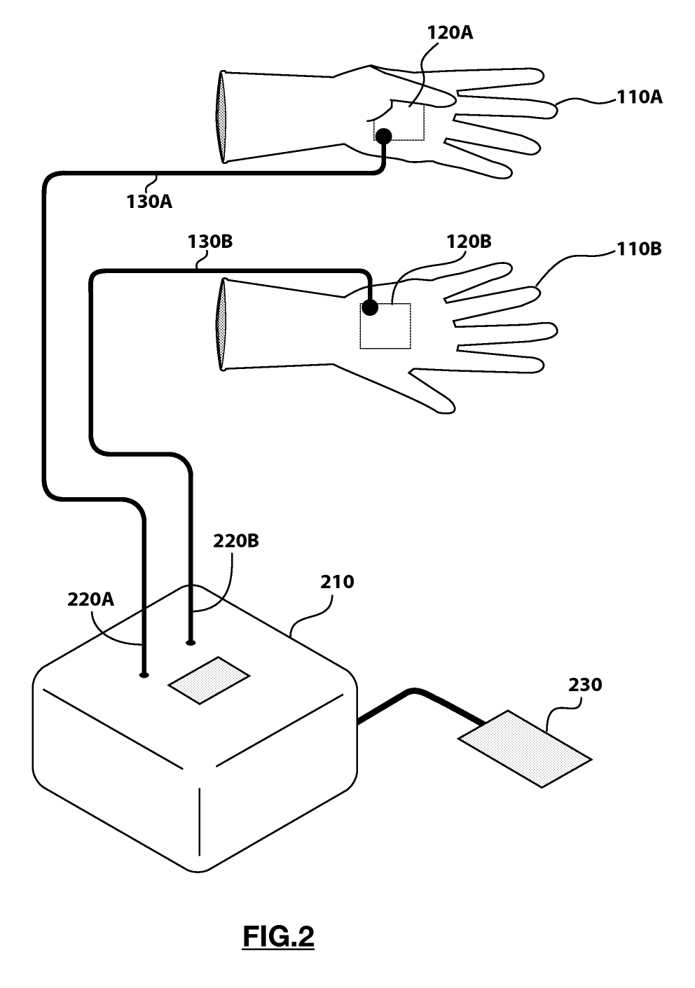

Now referring to FIG. 2 which shows the gloves 110A, 110B, the gloves 110A, 110B are connected to the conductive materials 120A, 120B, which are connected by electrodes 130A, 130B to the electrical terminals 220A, 220B of a pulsator 210. The pulsator 210 is operated by a switch 230, so that the conductive materials 120A, 120B are energized when the switch is closed 230. The voltage and current passing throught the conductive materials 130A, 130B is dependent on the settings of the pulsator 210 and the object held between the conductive materials 130A, 130B.

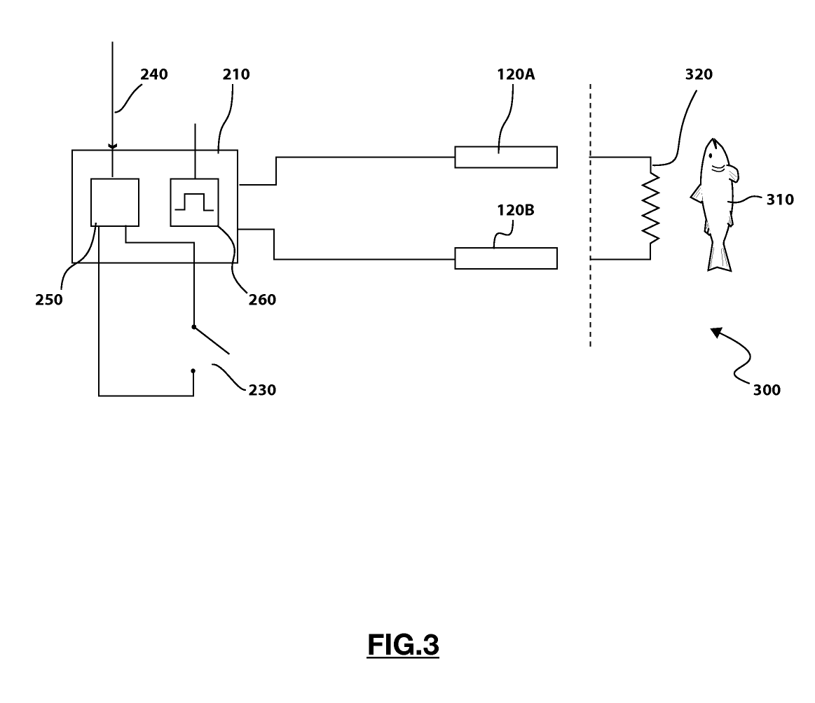

Now referring to FIG. 3 which illustrates a schematic of the aforementioned FIGS. 1 and 2. In FIG. 3, the conductive materials 120A, 120B are typically placed proximate to and in a conductive media (e.g. freshwater or saltwater) that surrounds a fish 310. The term “fish” not being limited to the small class of fish-like species, rather all aquatic animals that are confined in a liquid solution, typically being freshwater, saltwater, and/of brackish water. The electrical current flows from one side of the conductive material 120A to the other conductive material 120B and through the fish 310.

The current passing through the fish causes a physiological reaction that ranges from flight (small potential differences) to death (large potential differences). Intermediates states include electrotaxis (movement of the fish from the cathode to the anode) to electronarcosis (stunning of the fish due to the electrical current). Therefore, in referring back to FIG. 3, in conjunction with FIGS. 1 and 2, that the use of a pulsator 210 with a variable voltage setting 240, a power source 250, a power switch 230, and a waveform modulator 260 can produce a power source that can stun a fish.

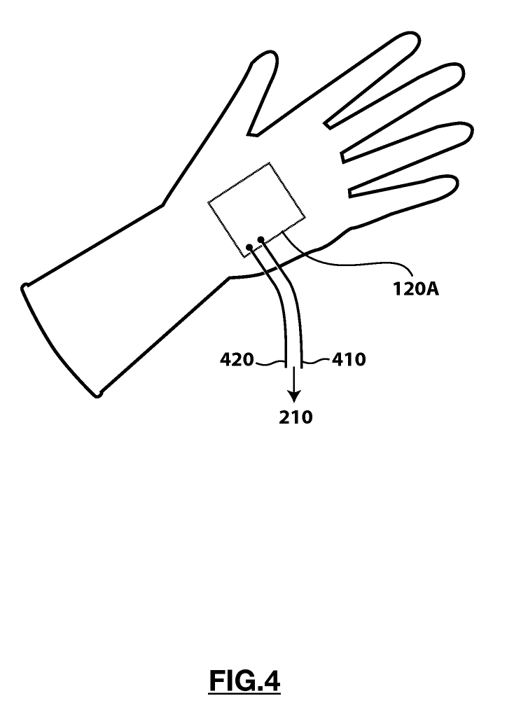

Now referring to FIG. 4 which depicts a variation of the glove and the conductive material 120A which also incorporates a pressure sensitive switch 410/420. This pressure sensitive switch 410/420 can be used to turn on/turn off the application of voltage. In these circumstances the voltage will only be applied when the glove grasps a fish. This “glove switch” can be used in the conjunction with an external switch so that the fish can be grasped with no electricity applied, then an external switch is used to apply electricity to the fish.

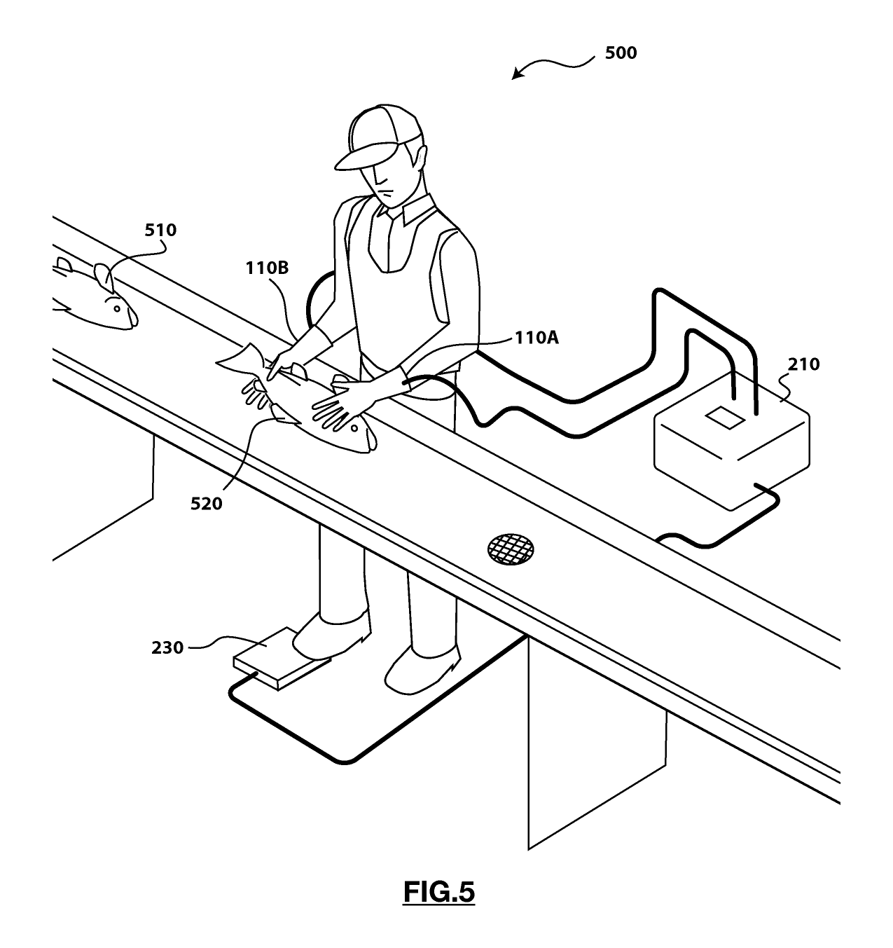

Now referring to FIG. 5 which shows the use of the inventive subject matter in a fish processing application. The fish 510 are transported down a conveyor 520 and grasped by the gloves 110A, 110B. The external switch 230 is used to activate the pulsator 210, so that current passes through the gloves 110A, 110B and through the fish 510.

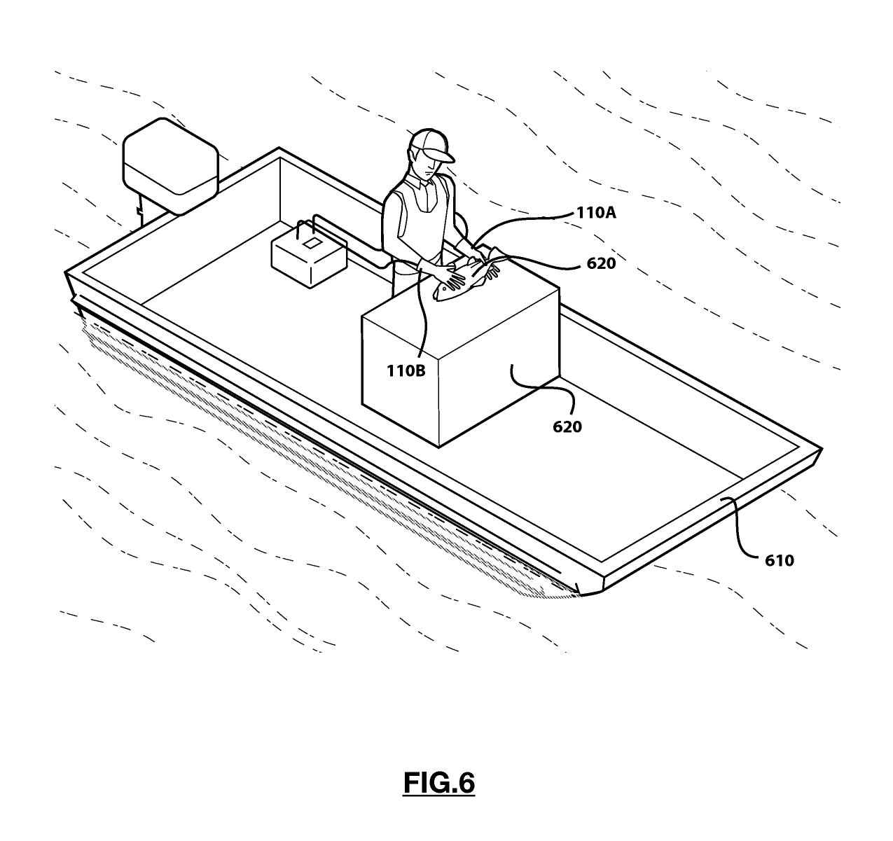

Now referring to FIG. 6 which illustrates the use of the gloves 110A, 110B which pass current through a fish on a platform 620 mounted on a boat 610.

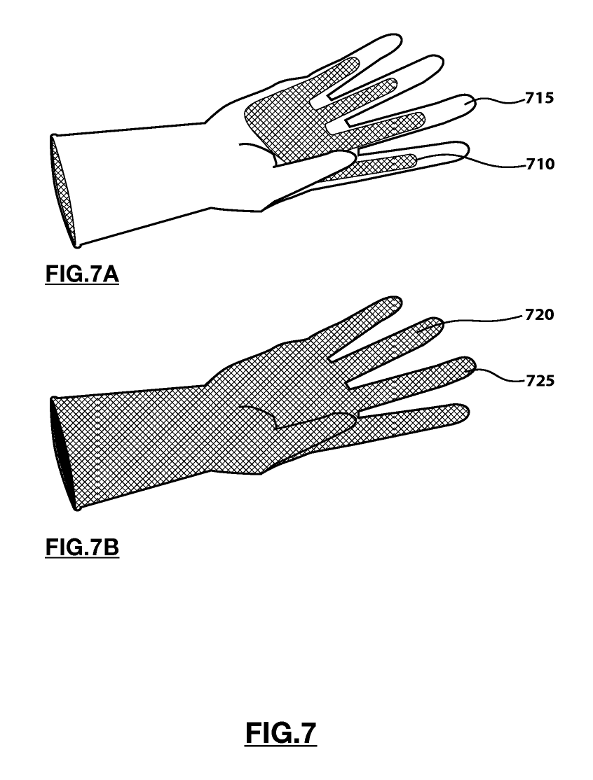

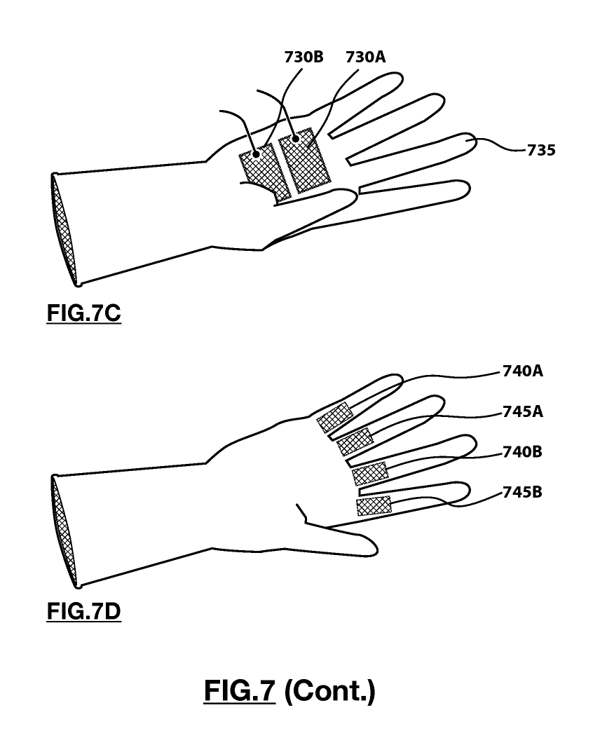

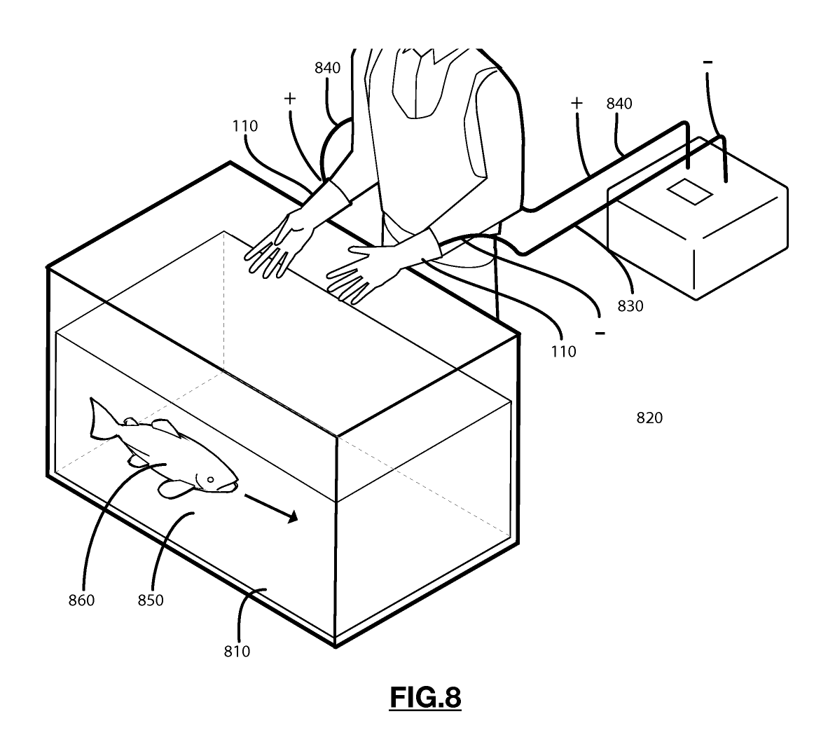

Now referring to FIGS. 7A-7D which illustrates different embodiments of the conductive material on the gloves. For example, FIG. 7A shows the conductive material being on the palm and also applied to a finger 715. FIG. 7B shows the conductive material being applied to the entire glove including the fingers. FIG. 7C illustrates the placement of opposite polarity electrodes 730A, 730B on the palm of the hand. FIG. 7D depicts the use of alternating opposite electrodes on the fingers of the hand. It is clear to one skilled in the arts that there are many variations of the electrodes that may be employed.

Now referring to FIG. 8 which shows the use gloves connected to a pulsator 210. The pulsator 210 is connected to the gloves 130A, 130B. The gloves 130A, 130B are placed in the water proximate to the fish 850 which causes and electric field 860 to be impressed across the fish 850.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

All patent and non-patent literature cited herein is hereby incorporated by references in its entirety for all purposes.

We claim:

1. An apparatus for the handling and affecting the physiological state of an aquatic species, said apparatus comprising:
a pair of gloves,
a multiplicity of electrodes, said electrodes attached to each glove;
a pulsator, said pulsator attached to the electrodes;
such that when the pulsator is activated, and the aquatic species is handled by the gloves, the current passing from one electrode to another, alters the physiological state of the aquatic species.

2. A method for the handling and affecting the physiological state of an aquatic species, said method comprising the steps of:
handling the aquatic species with a pair of gloves, wherein said gloves further comprise a multiplicity of electrodes, wherein said electrodes are attached to each glove, and a pulsator, said pulsator attached to the electrodes;
connecting the gloves to a pulsator,
activating the pulsator,
such that when the pulsator is activated, the physiological state of the aquatic species is affected.
